(19) United States
(12) Patent Application Publication
(10) Pub. No.: US 2013/0212541 A1
(43) Pub. Date: Aug. 15, 2013

(54) METHOD, A DEVICE AND A SYSTEM FOR RECEIVING USER INPUT

(71) Applicants: Andre Dolenc, Espoo (FI); Erkki Riekkola, Vantaa (FI)

(72) Inventors: Andre Dolenc, Espoo (FI); Erkki Riekkola, Vantaa (FI)

(73) Assignee: NOKIA CORPORATION, Espoo (FI)

(21) Appl. No.: 13/701,367

(22) PCT Filed: Jun. 1, 2010
(86) PCT No.: PCT/FI10/50445

§ 371 Date: Apr. 25, 2013

(51) Int. Cl. G06F 3/0488

(52) U.S. Cl. CPC G06F 3/04883
USPC 715/863

(57) ABSTRACT

The invention relates to a method, a device and system for receiving user input. User interface events are first formed from low-level events generated by a user interface input device such as a touch screen. The user interface events are modified by forming information on a modifier 5 for the user interface events such as time and coordinate information. The events and their modifiers are sent to a gesture recognition engine, where gesture information is formed from the user interface events and their modifiers. The gesture information is then used as user input to the apparatus. In other words, the gestures may not be 10 formed directly from the low-level events of the input device. Instead, user interface events are formed from the low-level events, and gestures are then recognized from these user interface events.

### BACKGROUND

Advances in computer technology have made it possible to manufacture devices that are powerful in terms of computing speed and yet easily movable or even pocket-sized like the contemporary mobile communication devices and multimedia devices. There are also ever more advanced features and software applications in familiar home appliances, vehicles for personal transportation and even houses. These advanced devices and software applications require input methods and devices that are capable enough for controlling them. Perhaps for this reason, touch input in forms of touch screens and touch pads has recently become more popular. Currently, such devices are able to replace more conventional input means like the mouse and the keyboard. However, implementing the input needs of the most advanced software applications and user input systems may require more than just a replacement of the conventional input means.

There is, therefore, a need for solutions that improve the usability and versatility of user input means such as touch screens and touch pads.

### SUMMARY

Now there has been invented an improved method and technical equipment implementing the method, by which the above problems may be at least alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

In one example embodiment, user interface events (higher-level events) are first formed from low-level events generated by a user interface input device such as a touch screen. The user interface events may be modified by forming information on a modifier for the user interface events such as time and coordinate information. The user interface events and their modifiers are sent to a gesture recognition engine, where gesture information is formed from the user interface events and possibly their modifiers. The gesture information is then used as user input to the apparatus. In other words, according to one example embodiment the gestures may not be formed directly from the low-level events of the input device. Instead, higher-level events i.e. user interface events are formed from the low-level events, and gestures are then recognized from these user interface events.

According to a first aspect, there is provided a method for receiving user input, comprising receiving a low-level event from a user interface input device, forming a user interface event using said low-level event, forming information on a modifier for said user interface event, forming gesture information from said user interface event and said modifier, and using said gesture information as user input to an apparatus.

According to an embodiment, the method further comprises forwarding said user interface event and said modifier to a gesture recognizer, and forming said gesture information by said gesture recognizer. According to an embodiment, the method further comprises receiving a plurality of user interface events from a user interface input device, forwarding said user interface events to a plurality of gesture recognizers, and forming at least two gestures by said gesture recognizers. According to an embodiment, the user interface event is one of the group of touch, release, move and hold. According to an embodiment, the method further comprises forming said modifier from at least one of the group of time information, area information, direction information, speed information, and pressure information. According to an embodiment, the method further comprises forming a hold user interface event in response to a touch input or key press input being held in place for a predetermined time, and using said hold event in forming said gesture information. According to an embodiment, the method further comprises receiving at least two distinct user interface events from a multi-touch touch input device, and using said at least two distinct user interface events for forming a multi-touch gesture. According to an embodiment, the user interface input device comprises at least one of the group of a touch screen, a touch pad, a pen, a mouse, a haptic input device, a data glove and a data suit. According to an embodiment, the user interface event is one of the group of touch down, release, hold and move.

According to a second aspect, there is provided an apparatus comprising at least one processor, memory including computer program code, the memory and the computer program code configured to, with the at least one processor, cause the apparatus to receive a low-level event from a user interface input module, form a user interface event using said low-level event, form information on a modifier for said user interface event, form gesture information from said user interface event and said modifier, and use said gesture information as user input to an apparatus.

According to an embodiment, the apparatus further comprises computer program code configured to cause the apparatus to forward said user interface event and said modifier to a gesture recognizer, and form said gesture information by said gesture recognizer. According to an embodiment, the apparatus further comprises computer program code configured to cause the apparatus to receive a plurality of user interface events from a user interface input device, forward said user interface events to a plurality of gesture recognizers, and form at least two gestures by said gesture recognizers. According to an embodiment, the user interface event is one of the group of touch, release, move and hold. According to an embodiment, the apparatus further comprises computer program code configured to cause the apparatus to form said modifier from at least one of the group of time information, area information, direction information, speed information, and pressure information. According to an embodiment, the apparatus further comprises computer program code configured to cause the apparatus to form a hold user interface event in response to a touch input or key press input being held in place for a predetermined time, and use said hold event in forming said gesture information. According to an embodiment, the apparatus further comprises computer program code configured to cause the apparatus to receive at least two distinct user interface events from a multi-touch touch input device, and use said at least two distinct user interface events for forming a multi-touch gesture. According to an embodiment, the user interface module comprises at least one of the group of a touch screen, a touch pad, a pen, a mouse, a haptic input device, a data glove and a data suit. According to an embodiment, the apparatus is one of a computer, portable communication device, a home appliance, an entertainment device such as a television, a transportation device such as a car, ship or an aircraft, or an intelligent building.

According to a third aspect, there is provided a system comprising at least one processor, memory including computer program code, the memory and the computer program code configured to, with the at least one processor, cause the system to receive a low-level event from a user interface input module, forming a user interface event using said low-level event, form information on a modifier for said user interface event, form gesture information from said user interface event and said modifier, and use said gesture information as user input to an apparatus. According to an embodiment, the system comprises at least two apparatuses arranged in communication connection to each other, wherein a first apparatus of said at least two apparatuses is arranged to receive said low-level event and a second apparatus of said at least two apparatuses is arranged to form said gesture information in response to receiving a user interface event from said first apparatus.

According to a fourth aspect, there is provided an apparatus comprising, processing means, memory means, and means for receiving a low-level event from a user interface input means, means for forming a user interface event using said low-level event, means for forming information on a modifier for said user interface event, means for forming gesture information from said user interface event and said modifier, and means for using said gesture information as user input to an apparatus.

According to a fifth aspect, there is provided a computer program product stored on a computer readable medium and executable in a data processing device, the computer program product comprising a computer program code section for receiving a low-level event from a user interface input device, forming a user interface event using said low-level event, a computer program code section for forming information on a modifier for said user interface event, a computer program code section for forming gesture information from said user interface event and said modifier, and a computer program code section for using said gesture information as user input to an apparatus. According to an embodiment, the computer program product is an operating system.

### DESCRIPTION OF THE DRAWINGS

In the following, various embodiments of the invention will be described in more detail with reference to the appended drawings, in which

FIG. 1 shows a method for gesture based user input according to an example embodiment;

FIG. 2 shows devices and a system arranged to receive gesture based user input according to an example embodiment;

FIGS. 3a and 3b show different example gestures composed of touch user interface events;

FIG. 4a shows a state diagram of a low-level input system according to an example embodiment;

FIG. 4b shows a state diagram of a user interface event system generating user interface events and comprising a hold state according to an example embodiment;

FIGS. 5a, 5b and 5c show examples of hardware touch signals such as micro-drag signals during a hold user interface event;

FIG. 6 shows a block diagram of levels of abstraction of a user interface system and a computer program product according to an example embodiment;

FIG. 7a shows a diagram of a gesture recognition engine according to an example embodiment;

FIG. 7b shows a gesture recognition engine in operation according to an example embodiment;

FIGS. 8a and 8b show generation of a hold user interface event according to an example embodiment;

FIG. 9 shows a method for gesture based user input according to an example embodiment; and

FIGS. 10a-10g show state and event diagrams for producing user interface events according to an example embodiment.

### DESCRIPTION OF THE EXAMPLE EMBODIMENTS

In the following, several embodiments of the invention will be described in the context of a touch user interface and methods and devices for the same. It is to be noted, however, that the invention is not limited to touch user interface. In fact, the different embodiments have applications widely in any environment where improvements of user interface operations are required. For example, devices with a large touch screen such as e-books and digital newspapers or personal computers and multimedia devices such as tablets and tables may benefit from the use of the invention. Likewise, user interface systems such as navigation interfaces of various vehicles, ships and aircraft may benefit from the invention. Computers, portable communication devices, home appliances, entertainment devices such as televisions, and intelligent buildings may also benefit from the use of the different embodiments. The devices employing the different embodiments may comprise a touch screen, a touch pad, a pen, a mouse, a haptic input device, a data glove or a data suit. Also, three-dimensional input systems e.g. based on haptics may use the invention.

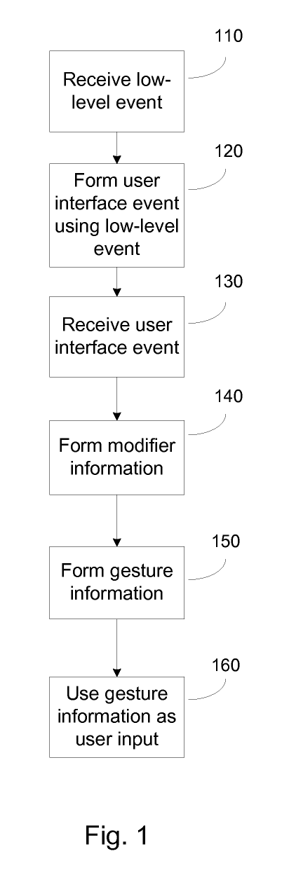

FIG. 1 shows a method for gesture based user input according to an example embodiment. At stage 110, a low-level event is received. The low-level events may be generated by the operating system of the computer as a response to a person using an input device such as a touch screen or a mouse. The user interface events may also be generated directly by specific user input hardware, or by the operating system as a response to hardware events.

At stage 120, at least one user interface event is formed or generated. The user interface events may be generated from the low-level events e.g. by averaging, combining, thresholding, by using timer windows or by using filtering, or by any other means. For example, two low-level events in sequence may be interpreted as a user interface event. User interface events may also be generated programmatically for example from other user interface events or as a response to a trigger in the program. The user interface events may be generated locally by using user input hardware or remotely e.g. so that the low-level events are received from a remote computer acting as a terminal device.

At stage 130, at least one user interface event is received. There may be a plurality of user interface events received, and user interface events may be combined together, split and grouped together and/or used as such as individual user interface events. The user interface events may be received from the same device e.g. the operating system, or the user interface events may be received from another device e.g. over a wired or wireless communication connection. Such another device may be a computer acting as a terminal device to a service, or an input device connected to a computer, such as a touch pad or touch screen.

At stage 140, modifier information for the user interface event is formed. The modifier information may be formed by the operating system from the hardware events and/or signals or other low-level events and data, or it may be formed by the hardware directly. The modifier information may be formed at the same time with the user interface event, or it may be formed before or after the user interface event. The modifier information may be formed by using a plurality of lower-level events or other events. The modifier information may be common to a number of user interface events or it may be different for different user interface events. The modifier information may comprise position information such as a point or area on the user interface that was touched or clicked, e.g. in the form of 2-dimensional or 3-dimensional coordinates. The modifier information may comprise direction information e.g. on the direction of movement, drag or change of the point of touch or click, and the modifier may also comprise information on speed of this movement or change. The modifier information may comprise pressure data e.g. from a touch screen, and it may comprise information on the area that was touched, e.g. so that it can be identified whether the touch was made by a finger or by a pointing device. The modifier information may comprise proximity data e.g. as an indication of how close a pointer device or a finger is from a touch input device. The modifier information may comprise timing data e.g. the time a touch lasted, or the time between consecutive clicks or touches, or clock event information or other time related data.

At stage 150, gesture information is formed from at least one user interface event and the respective modifier data. The gesture information may be formed by combining a number of user interface events. The user interface event or events and the respective modifier data are analyzed by a gesture recognizer that outputs a gesture signal whenever a predetermined gesture is recognized. The gesture recognizer may be a state machine, or it may be based on pattern recognition of other kind, or it may be a program module. A gesture recognizer may be implemented to recognize a single gesture or it may be implemented to recognize multiple gestures. There may be one or more gesture recognizers operating simultaneously, in a chain or partly simultaneously and partly in chain. The gesture may be, for example, a touch gesture such as a combination of touch/tap, move/drag and/or hold events, and it may require a certain timing (e.g. speed of double-tap) or range or speed of movement in order to be recognized. The gesture may also be relative in nature, that is, it may not require any absolute timings or ranges or speeds, but may depend on the relative timings, ranges and speeds of the parts of the gesture.

At stage 160, the gesture information is used as user input. For example, a menu option may be triggered when a gesture is detected, or a change in the mode or behavior of the program may be actuated. The user input may be received by one or more programs or by the operating system, or by both. The behavior after receiving the gesture may be specific to the receiving program. The receiving of the gesture by the program may start even before the gesture has been completed so that the program can prepare for action or start the action as a response to the gesture even before the gesture has been completed. At the same time, one or more gestures may be formed and used by the programs and/or the operating system, and the control of the programs and/or the operating system may happen in a multi-gesture manner. The forming of the gestures may take place simultaneously or it may take place in a chain so that first, one or more gestures are recognized, and after that other gestures are recognized. The gestures may comprise single-touch or multi-touch gestures, that is, they may comprise a single point of touch or click, or they may comprise multiple points of touch or click. The gestures may be single gestures or multi-gestures. In multi-gestures, two or more essentially simultaneous or sequential gestures are used as user input. In multi-gestures, the underlying gestures may be single-touch or multi-touch gestures.

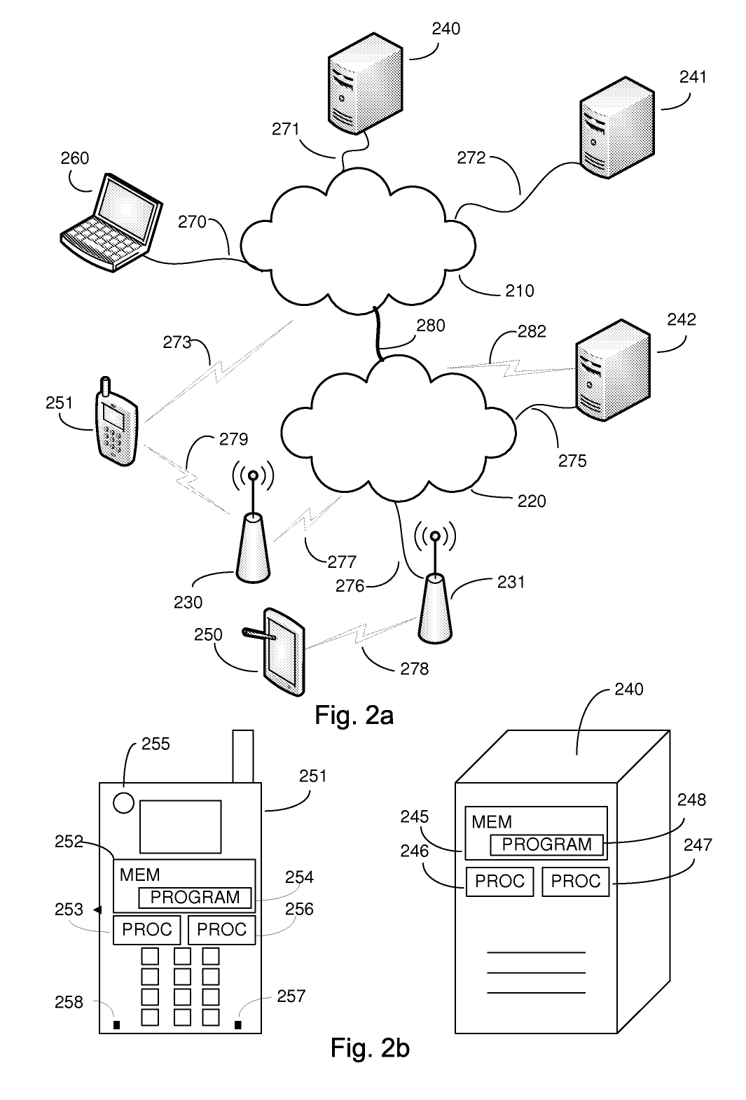

FIG. 2 shows devices and a system arranged to receive gesture based user input according to an example embodiment. The different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 2a are shown a server 240 for offering a network service requiring user input and connected to the fixed network 210, a server 241 for processing user input received from another device in the network and connected to the fixed network 210, and a server 242 for offering a network service requiring user input and for processing user input received from another device and connected to the mobile network 220. Some of the above devices, for example the computers 240, 241, 242 may be such that they make up the Internet with the communication elements residing in the fixed network 210.

There are also a number of end-user devices such as mobile phones and smart phones 251, Internet access devices (Internet tablets) 250 and personal computers 260 of various sizes and formats. These devices 250, 251 and 260 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices for receiving user input according to an example embodiment. As shown in FIG. 2b, the server 240 contains memory 245, one or more processors 246, 247, and computer program code 248 residing in the memory 245 for implementing, for example, gesture recognition. The different servers 241, 242, 290 may contain at least these same elements for employing functionality relevant to each server. Similarly, the end-user device 251 contains memory 252, at least one processor 253 and 256, and computer program code 254 residing in the memory 252 for implementing, for example, gesture recognition. The end-user device may also have at least one camera 255 for taking pictures. The end-user device may also contain one, two or more microphones 257 and 258 for capturing sound. The different end-user devices 250, 260 may contain at least these same elements for employing functionality relevant to each device. Some end-user devices may be equipped with a digital camera enabling taking digital pictures, and one or more microphones enabling audio recording during, before, or after taking a picture.

It needs to be understood that different embodiments allow different parts to be carried out in different elements. For example, receiving the low-level events, forming the user interface events, receiving the user interface events, forming the modifier information and recognizing gestures may be carried out entirely in one user device like 250, 251 or 260, or receiving the low-level events, forming the user interface events, receiving the user interface events, forming the modifier information and recognizing gestures may be entirely carried out in one server device 240, 241, 242 or 290, or receiving the low-level events, forming the user interface events, receiving the user interface events, forming the modifier information and recognizing gestures may be carried out across multiple user devices 250, 251, 260 or across multiple network devices 240, 241, 242, 290, or across user devices 250, 251, 260 and network devices 240, 241, 242, 290. For example, low-level events may be received in one device, the user interface events and the modifier information may be formed in another device and the gesture recognition may be carried out in a third device. As another example, the low-level events may be received in one device, and formed into user interface events together with the modifier information, and the user interface events and the modifier information may be used in a second device to form the gestures and using the gestures as input. Receiving the low-level events, forming the user interface events, receiving the user interface events, forming the modifier information and recognizing gestures may be implemented as a software component residing on one device or distributed across several devices, as mentioned above, for example so that the devices form a so-called cloud. Gesture recognition may also be a service where the user device accesses the service through an interface. In a similar manner, forming modifier information, processing user interface events and using the gesture information as input may be implemented with the various devices in the system.

The different embodiments may be implemented as software running on mobile devices and optionally on services. The mobile phones may be equipped at least with a memory, processor, display, keypad, motion detector hardware, and communication means such as 2G, 3G, WLAN, or other. The different devices may have hardware like a touch screen (single-touch or multi-touch) and means for positioning like network positioning or a global positioning system (GPS) module. There may be various applications on the devices such as a calendar application, a contacts application, a map application, a messaging application, a browser application, and various other applications for office and/or private use.

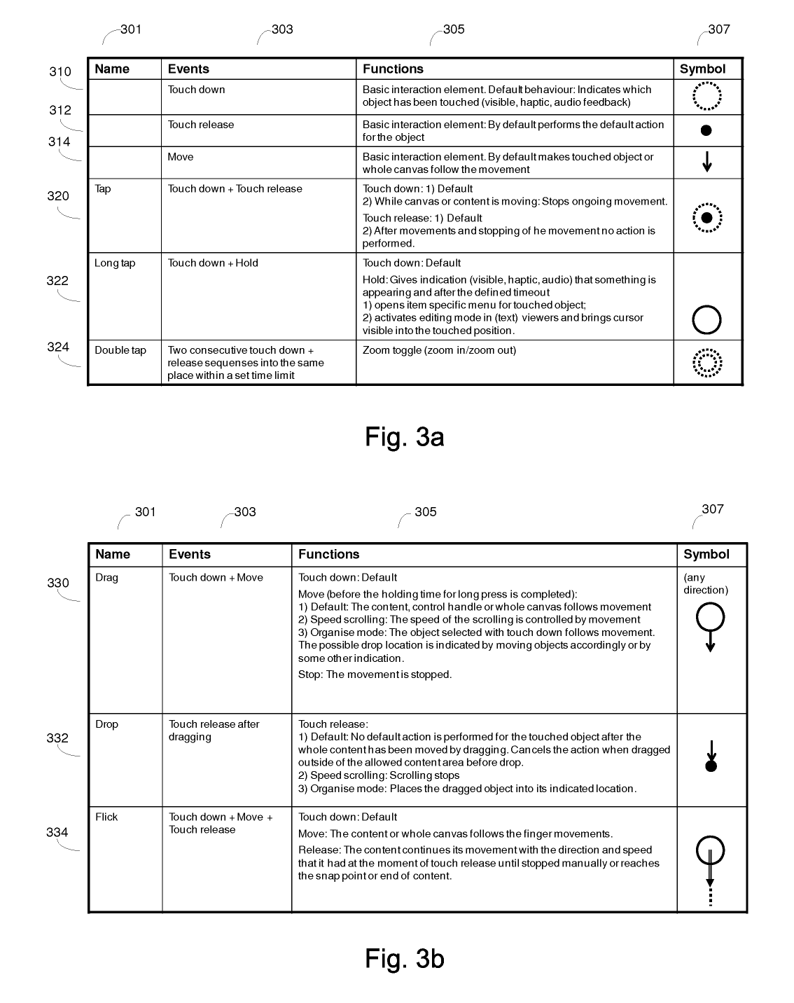

FIGS. 3a and 3b show different examples of gestures composed of touch user interface events. In the figure, column 301 shows the name of the gesture, column 303 shows the composition of the gesture as user interface events, column 305 displays the behavior or use of the gesture in an application or by the operating system and column 307 indicates a possible symbol for the event. In the example of FIG. 3a, Touch down user interface event 310 is a basic interaction element, whose default behaviour is to indicate which object has been touched, and possibly a visible, haptic, or audio feedback is provided. Touch release event 312 is another a basic interaction element that by default performs the default action for the object, for example activates a button. Move event 314 is a further basic interaction element that by default makes the touched object or the whole canvas follow the movement.

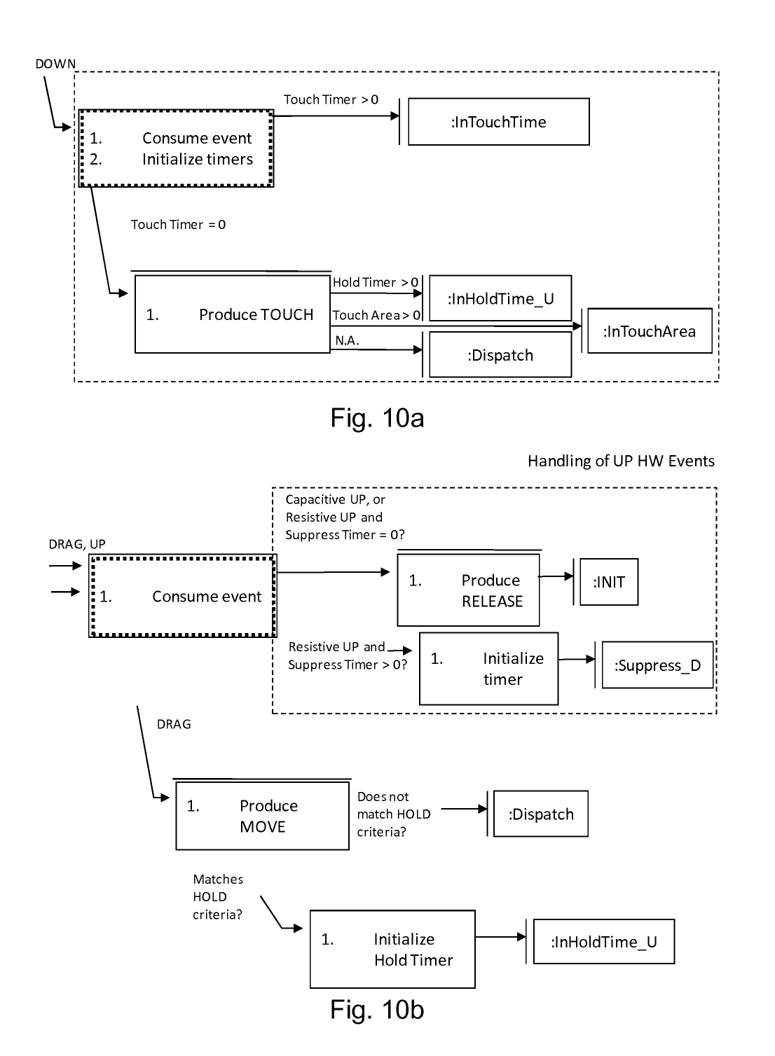

According to one example embodiment a gesture is a composite of user interface events. A Tap gesture 320 is a combination of a Touch down and Release events. The Touch down and Release events in the Tap gesture may have default behaviour, and the Tap gesture 320 may in addition have special behaviour in an application or in the operating system. For example, while the canvas or the content is moving, a Tap gesture 320 may stop ongoing movement. A Long Tap gesture 322 is a combination of Touch down and Hold events (see description of Hold event later in connection with FIGS. 8a and 8b). The Touch down event inside the Long Tap gesture 322 may have default behavior, and the Hold event inside the Long Tap gesture 322 may have specific additional behavior. For example, an indication (visible, haptic, audio) that something is appearing may be given, and after a predefined timeout, a specific menu for the touched object may be opened or editing mode in (text) viewers may be activated and a cursor may be brought visible into the touched position. A Double Tap gesture 324 is a combination of two consecutive touch down and release events essentially at the same location within a set time limit. A Double Tap gesture may e.g. be used as a zoom toggle (zoom in/zoom out) or actuating the zoom in other ways, or as a trigger for some other specific behaviour. Again, the use of the gesture may be specific to the application.

In FIG. 3b, a Drag gesture 330 is a combination of Touch down and Move events. The touch down and move events may have default behaviour, while the Drag gesture as a whole may have specific behaviour. For example, by default, the content, a control handle or the whole canvas may follow the movement of the Drag gesture. Speed scrolling may be implemented by controlling the speed of the scrolling by finger movement. A mode to organize user interface elements may be implemented so that the object selected with touch down follows the movement, and the possible drop location is indicated by moving objects accordingly or by some other indication. A Drop gesture 332 is a combination of user interface events that make up dragging and a Release. At the Release, no default action may be performed for the touched object after the whole content has been moved by dragging, and the Release may cancel the action when dragged outside of the allowed content area before Drop. In speed scrolling, Drop may stop scrolling, and in the organise mode, the dragged object may be placed into its indicated location. A Flick gesture 334 is a combination of Touch down, Move and Touch Release. After Release, the content continues its movement with the direction and speed that it had at the moment of touch release. The content may be stopped manually or when it reaches a snap point or end of content, or it may slow down to stop on its own.

Dragging (panning) and flicking gestures may be used as default navigation strokes in lists, grids and content views. The user may manipulate the content or canvas to make it follow the direction of move. Such way of manipulation may make scrollbars as active navigation elements to be unnecessary, which brings more space to the user interface. Consequently, a scrolling indication may be used to indicate that more items are available, e.g. with graphical effects like dynamic gradient, haze etc., or a thin scroll bar appearing when scrolling is ongoing (indication only, not active). An index (for sorted lists) may be shown when the scrolling speed is too fast for user to follow the content visually.

Flick scrolling may continue at the end of the flick gesture, and the speed may be determined according to the speed at the end of flick. Deceleration or inertia may not be applied at all, whereby the movement continues frictionless until the end of canvas or until stopped manually with touch down. Alternatively, deceleration or inertia may be applied in relation to the length of scrollable area, until certain defined speed is reached. Deceleration may be applied smoothly before the end of the scrollable area is reached. Touch down after Flick scrolling may stop the scrolling.

Drag and Hold gestures at the edge of the scroll area may activate speed scrolling. Speed of the scroll may be controlled by moving the finger between the edge and centre of the scroll area. Content zoom animation may be used to indicate the increasing/decreasing scrolling speed. Scrolling may be stopped by lifting the finger (touch release) or by dragging the finger into the middle of the scrolling area.

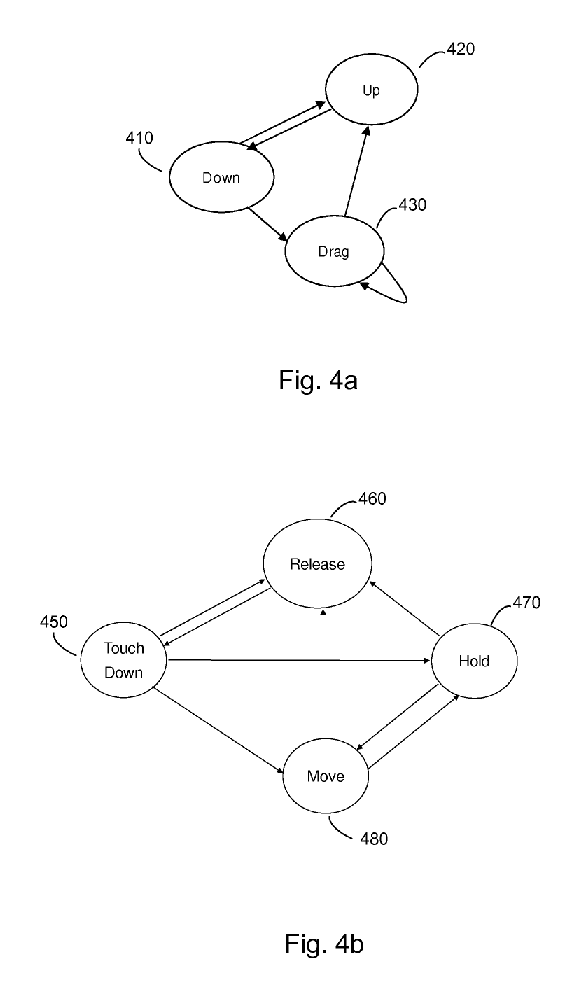

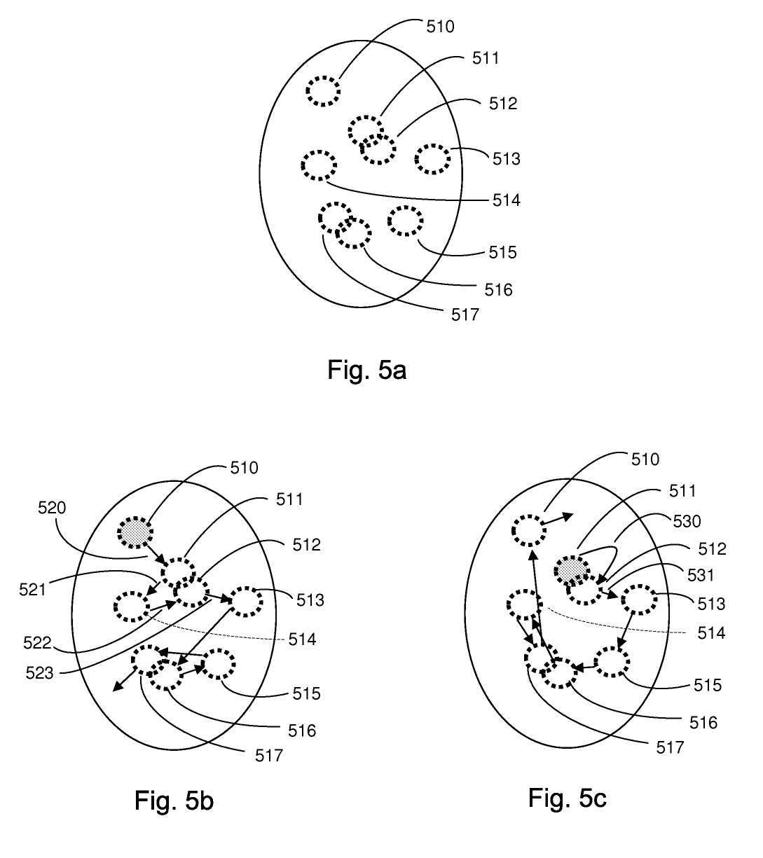

FIG. 4a shows a state diagram of a low-level input system according to an example embodiment. Such an input system may be used e.g. to receive hardware events from a touch screen or another kind of a touch device, or some other input means manipulated by a user. The down event 410 is triggered from the hardware or from the driver software of the hardware when the input device is being touched. An up event 420 is triggered when the touch is lifted, i.e. the device is no longer touched. The up event 420 may also be triggered when there is no movement even though the device is being touched. Such up events may be filtered out by using a timer. A drag event 430 may be generated when after a down event, the point of touch is being moved. The possible state transitions are indicated by arrows in FIG. 4a and they are: down-up, up-down, down-drag, drag-drag and drag-up. Before utilizing the hardware events, e.g. for creating user interface events, the hardware events may be modified. For example, noisy events may be averaged or filtered in another way. Furthermore, the touch point may be moved towards the finger tip, depending on the orientation and type of the device.

FIG. 4b shows a state diagram of a user input system generating user interface events and comprising a hold state according to an example embodiment. A Touch Down state or user interface event 450 occurs when a user touches a touch screen, or for example presses a mouse key down. In this Touch Down state, the system has determined that the user has activated a point or an area, and the event or state may be supplemented by modifier information such as the duration or pressure of the touch. From the Touch Down state 450 it is possible to change to the Release state or event 460 when the user releases the button or lifts the touch from the touch screen. The Release event may be supplemented e.g. by a modifier indicative of the time from the Touch Down event. After the Release state, a Touch Down event or state 450 may occur again.

If the point of touch or click is moved after the Touch Down user interface event (without lifting the touch), a Move event or state 480 occurs. A plurality of Move events may be triggered if the moving of the point of touch spans a long enough time. The Move event 480 (or plurality of move events) may be supplemented by modifier information indicative of the direction of the move and the speed of the move. The Move event 480 may be terminated by lifting the touch, and a Release event 460 occurs. The Move event may be terminated also by stopping the move without lifting the touch, in which case a Hold event 470 may occur, if the touch spans a long enough time without moving.

A Hold event or state 470 may be generated when a Touch Down or Move event or state continues for a long enough time. The generation of the Hold event may be done e.g. so that a timer is started at some point in the Touch Down or Move state, and when the timer advances to a large enough value, a Hold event is generated, in case the state is still Touch Down or Move, and the point of touch has not moved significantly. A Hold event or state 470 may be terminated by lifting the touch, causing a Release event 460 to be triggered, or by moving the point of activation, causing a Move event 480 to be triggered. The existence of the Hold state or event may bring benefits in addition to just having a Touch Down event in the system, for example by allowing an easier and more reliable detection of gestures.

There may be noise in the hardware signals generated by the user input device e.g. due to the large area of the finger, due to the characteristics of the touch screen, or both. There may be many kinds of noise imposed on top of the baseline path. This noise may be so-called white noise, pink noise or noise of another kind. The different noise types may be generated by different types of error sources in the system. Filtering may be used to remove errors and noise.

The filtering may happen directly in the touch screen or other user input device, or it may happen later in the processing chain, e.g. in the driver software or the operating system. The filter here may be a kind of an average or mean filter, where the coordinates of a number of consecutive points (in time or in space) are averaged by an un-weighted or weighted average or another like kind of processing or filter where the coordinate values of the points are processed to yield a single set of output coordinates. As a result, the noise may be significantly reduced, e.g. in the case of white noise, by a factor of square root of N, where N is the number of points being averaged.

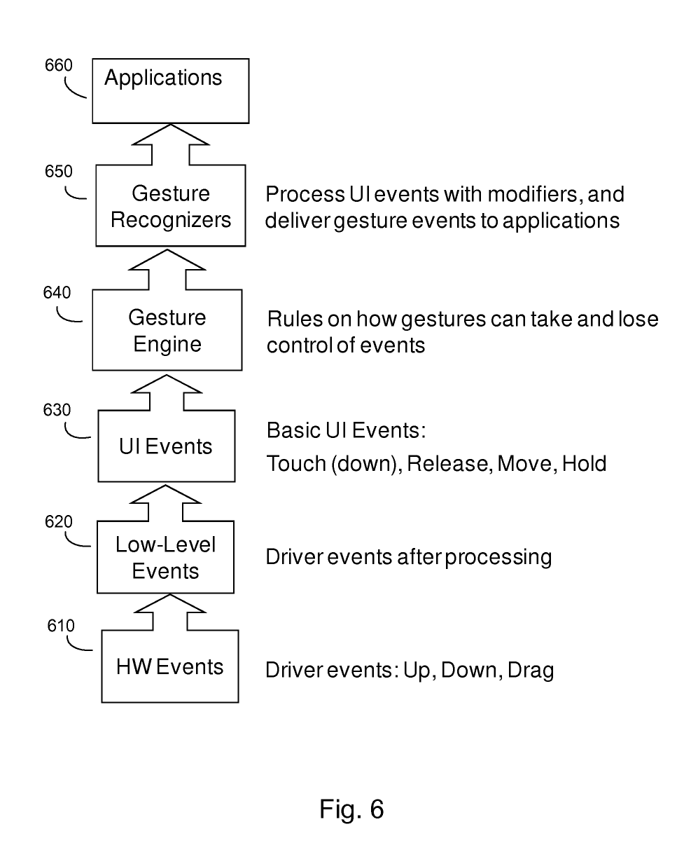

FIGS. 5a, 5b and 5c show examples of hardware touch signals such as micro-drag signals during a generation of a hold user interface event. A hold user interface event is generated by the user holding the finger on a touch screen or mouse pressed down for at least a predetermined time. A finger presses on a fairly large area on the touch screen, and a mouse may make small movements when pressed down. These phenomena cause a degree of uncertainty to the generated low-level events. For example, the same hand and the same hardware can lead to different low-level event xy-pattern depending on how the user approaches the device. This is illustrated in FIG. 5a, where a number of low-level touch down events 510-517 are generated near each other.

In FIGS. 5b and 5c, two different sequences from the same low-level touch down and move events 510-517 are shown. In FIG. 5b, the first event to be received is the event 510, and the second is the event 511. The sequence continues to events 514, 512, 513, 516, 515 and 517, and after that the move continues towards the lower left corner. The different move vectors between the events are indicated by arrows 520, 521, 522, 523 and so on. In FIG. 5c, the sequence is different. It starts from the event 511, and continues to 512, 513, 515, 516, 514, and 517 and ends at 510. After the end point, the move continues towards the upper right corner. The move vectors 530, 531 and so on between the events are completely different than in FIG. 5b. This causes a situation where any SW that would need to process the driver events during Touch Down as such (without processing) could be more or less random, or at least hardware-dependent. This would make the interpretation of gestures more difficult. The example embodiments of the invention may alleviate this newly recognized problem. Even user interface controls like buttons may benefit from a common implementation of the touch down user interface event, where a driver or the layer above the driver converts the set of low-level or hardware events to a single Touch Down event. A Hold event may be detected in a like manner as Touch down, thereby making it more reliable to detect and interpret gestures like Long Tap, Panning and Scrolling.

The low-level events may be generated e.g. by sampling with a certain time interval such as 10 milliseconds. When the first touch down event is received from the hardware, a timer may be started. During a predetermined time, the events from the hardware are followed, and if they stay within a certain area, a touch down event may be generated. On the other hand, if the events (touch down or drag) migrate outside the area, a touch down user interface event followed by a move user interface event are generated. When the first touch down event from the hardware is received, the area may be larger in order to allow a “sloppy touch”, wherein the user touches the input device carelessly. The accepted area may then later be reduced to be smaller so that the move user interface event may be generated accurately. The area may be determined to be an ellipse, a circle, a square, a rectangle or any other shape. The area may be positioned according to the first touch down event or as an average of the position of a few events. If the touch down or move hardware events continue to be generated for a longer time, a hold user interface event may be generated.

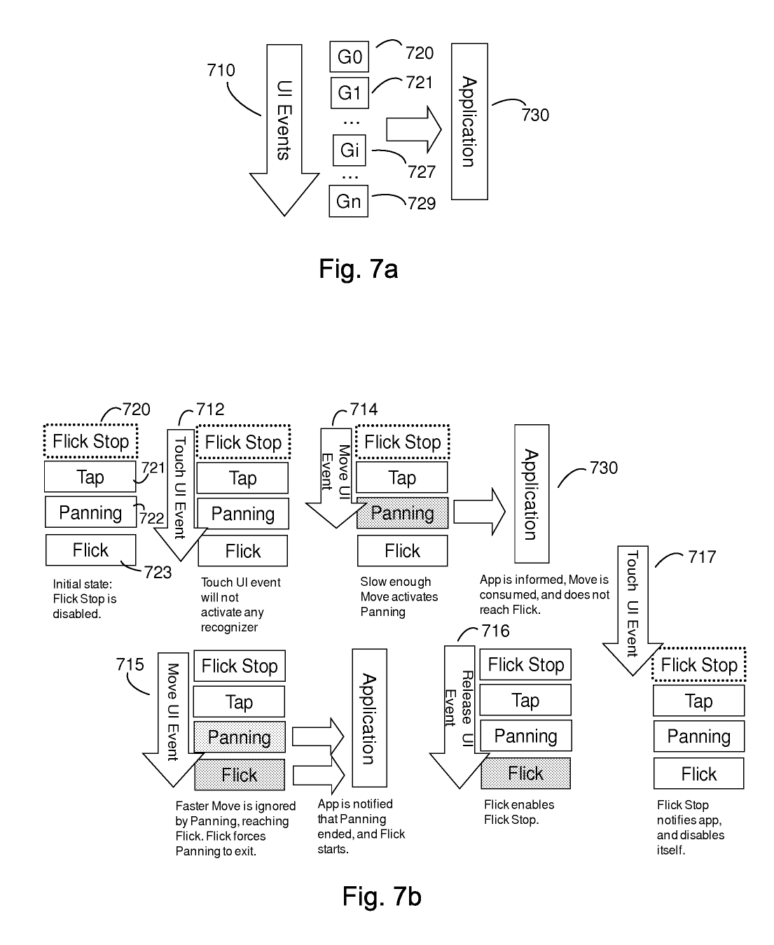

FIG. 6 shows a block diagram of levels of abstraction of a user interface system and a computer program product according to an example embodiment. The user interface hardware may generate hardware events or signals or driver events 610, for example Up, Down and Drag driver or low-level events. The implementation of these events may be hardware-dependent, or they may function more or less similarly on every hardware. The driver events 610 may be processed by the window manager (or the operating system) to generate processed low-level events 620. According to an example embodiment, the low-level events may be used to form user interface events 630 such as Touch Down, Release, Move and Hold, as explained earlier. These user interface events 630, with modifiers, may be forwarded to a gesture engine 640 that may operate to specify rules on how gesture recognizers 650 may take and lose control of events. Gesture recognizers 650 process User Interface Events 630 with their respective modifiers in order to recognize the beginning of a gesture and/or the whole gesture. The recognized gestures are then forwarded to applications 660 and the operating system to be used for user input.

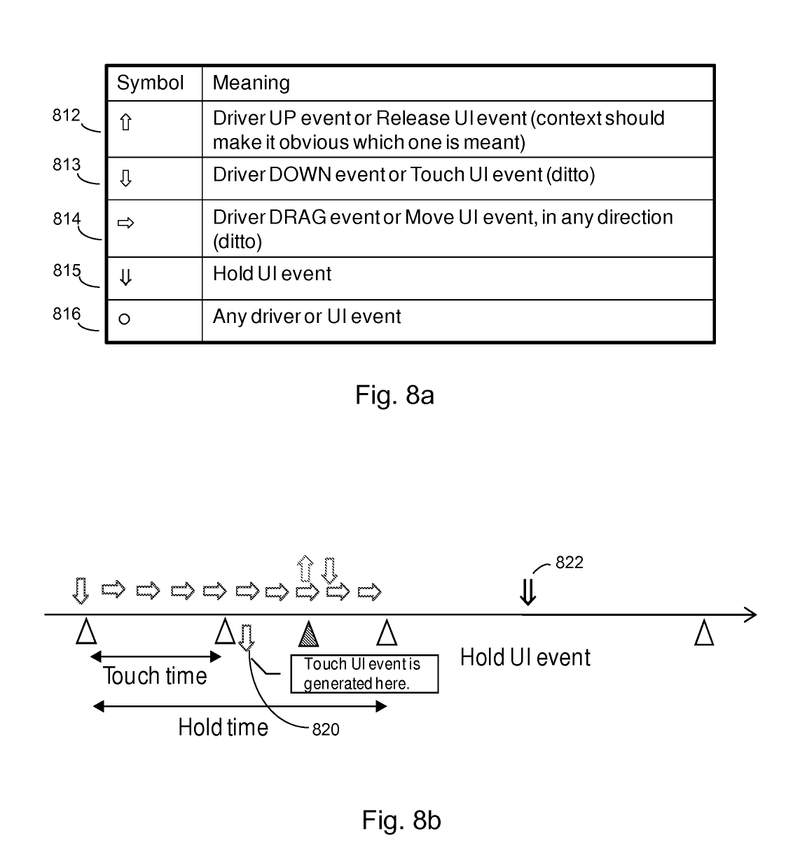

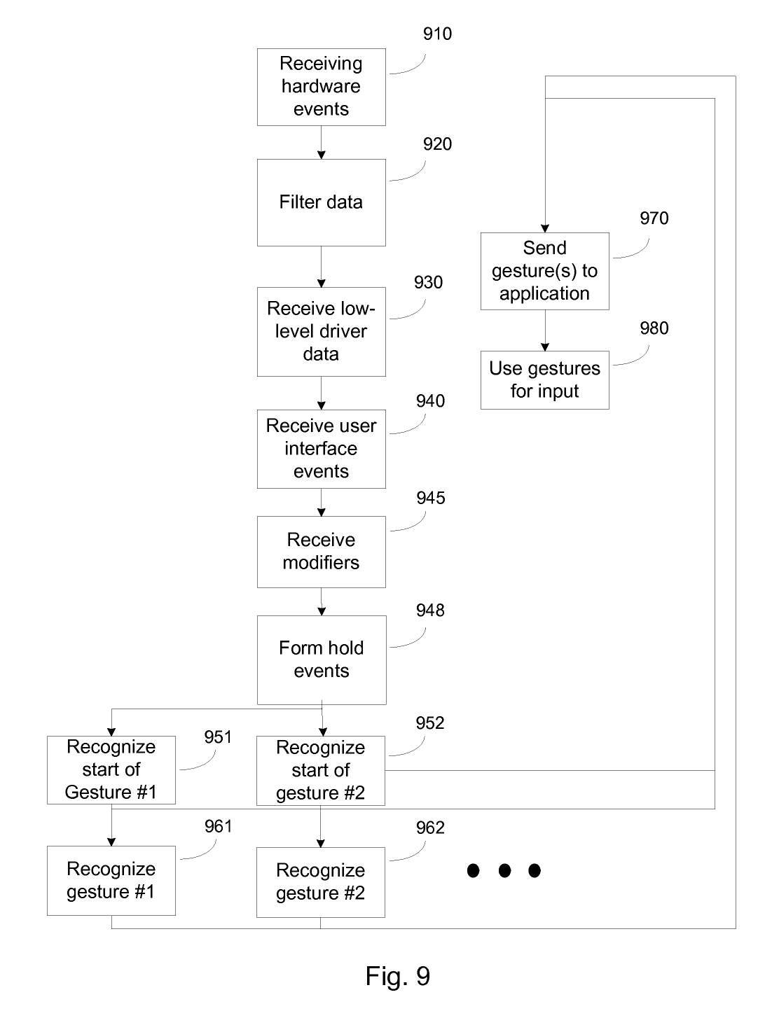

FIG. 7a shows a diagram of a gesture recognition engine according to an example embodiment. User interface events 710 such as Touch, Release, Move and Hold are sent to gesture recognizers 720, 721, . . . , 727, . . . 729. There may be a control means that sends the user interface events to the different recognizers conditionally or in a certain order, or the user interface events may be passed to the different recognizers as such independently of other recognizers. The user interface events 710 may comprise modifier information to give more data to the recognizers, e.g. the direction or speed of the movement. The gesture recognizers operate on the user interface events and the modifier information, and generate gesture signals as output when a gesture is recognized. This gesture signal and associated data on the specific gesture may then be sent to an application 730 for use as user input. The gesture engine and/or gesture recognizers may be configured/used to also “filter” the gestures that are forwarded to applications. Consider two applications, a Window manager and the Browser. In both cases, the gesture engine may be configured to capture the gestures that are meant to be handled by these applications, instead of the individual applications on the screen capturing the gestures. This may bring the advantage, that e.g. in a browser application, gestures like panning may behave the same way even if the Web page contains a Flash area or is implemented as a Flash program entirely.

FIG. 7b shows a gesture recognition engine in operation according to an example embodiment. In the example, there are four gesture recognizers for Flick Stop 720, Tap 721, Panning 722 and Flick 723. In the initial state, the Flick Stop recognizer 720 is disabled, since there is no Flick ongoing, and therefore stopping a Flick gesture is irrelevant. When a Touch user interface event 712 is sent to the recognizers, none of them may react to it, or they may react merely by sending an indication that a gesture may be starting. When the Touch 712 is followed by a Move user interface event 714, the gesture recognizer 721 is not activated, but the gesture recognizer 722 for Panning is activated, and the recognizer informs an application 730 that panning is to be started. The gesture recognizer 722 may also give information on the speed and direction of panning. After the gesture recognizer 722 recognizes Panning, the input user interface event 714 is consumed and does not reach other recognizers, i.e. the recognizer 723. Here, the user interface event is passed to different recognizers in certain order, but the event could also be passed to recognizers simultaneously.

In case the user interface event Move is a fast Move 715, the event will not be caught by the recognizer 722 for Panning. Instead, the recognizer 723 for Flick gesture will be activated. As a result, the Panning recognizer 722 may send an indication that Panning is ending, and the Flick recognizer 723 may send information on Flick gesture starting to the application 730, along with information on speed and direction of the flick. Furthermore, since the gesture Flick is now ongoing, the recognizer 720 for Flick Stop is enabled. After the Move user interface event 715, a Release user interface event 716 is received when the user releases the press, and the Flick gesture remains active (and Flick Stop remains enabled). When the user now touches the screen, a Touch user interface event 717 is received. This event is captured by the Flick Stop recognizer 720 that notifies the application 730 that Flick is to be stopped. The recognizer 720 for Flick Stop also disables itself, since now there is no Flick gesture ongoing any more.

The gesture engine and/or the individual gesture recognizers may reside in an application, in a program library used by the applications, in the operating system, or in a module closely linked with the operating system, or any combination of these and other meaningful locations. The gesture engine and the recognizers may also be distributed across several devices.

The gesture engine may be arranged to reside in or close to the operating system, and applications may register the gestures they wish to receive with the gesture engine. There may be gestures and gesture chains available in the gesture engine or in a library, or an application may provide and/or define them. An application or the operating system may also modify the operation of the gesture engine and the parameters (such as timers) of individual gestures. For example, the order of the gestures to be recognized in a gesture chain may be defined and/or altered, and gestures may be enabled and disabled. Also, the state of an application or the operating system or the device may cause a corresponding set or chain of gesture recognizers to be selected so that a change in the state of the application causes a change in how the gestures are recognized. The order of gesture recognizers may have an effect on the functionality of the gesture engine: e.g. flick stop may be first in a chain, and in single-touch operation, gestures that are location specific may come earlier than generic gestures. Also, multi-touch gestures may be recognized first, and the left-over events may then be used by the single-touch gesture recognizers.

When a recognizer attached to the gesture engine has recognized a gesture, information on the gesture needs to be sent to an appropriate application and/or the appropriate process. For this, it needs to be known which gesture was recognized, and where the recognition started, ended or took place. Using the location information and information on the gesture, the gesture engine may send the gesture information to the appropriate application or window. A gesture such as move or double tap may be initiated in one window and end in another window, in which case the gesture recognizer may, depending on the situation, send the gesture information to the first window, the second window or both windows. In the case there are multiple touch points on the screen, a gesture recognizer may also choose which event stream or which event streams to use. For this purpose, the gesture recognizer may be told how many input streams there are.

Multiple simultaneous gestures may also be recognized. For example, a long tap gesture may be recognized simultaneously with a drag gesture. For multi-gesture recognition, the recognizers may be arranged to operate simultaneously, or so that they operate in a chain. For example, the multi-gesture recognition may happen after a multi-touch recognition and operate on the events not used by the multi-touch recognition. The gestures recognized in a multi-gesture may be wholly or partly simultaneous, or they may be sequential, or both. The gesture recognizers may be arranged to communicate with each other, or the gesture engine may detect that a multi-gesture was recognized. Alternatively, the application may use multiple gestures from the gesture engine as a multi-gesture.

FIGS. 8a and 8b show generation of a hold user interface event according to an example embodiment. In FIG. 8a, the low-level events or driver events used as input for generating the hold event are explained. The arrow up 812 indicates a driver up or release event. The arrow down 813 indicates a driver down event or touch user interface event. The arrow right 814 indicates a drag or move user interface event (in any direction). The open arrow down 815 indicates the generated hold user interface event. Other events 816 are marked with a circle.

In FIG. 8b, the sequence begins with a driver down event 813. At this point, at least one timer may be started to detect the time the touch or down state lasts. While the user holds the touch or mouse down or drags it, a sequence of driver drag events is generated. These events may be a series of micro-drag events, as explained earlier. After a predetermined time has elapsed and this has been detected e.g. by a timer, a Touch user interface event is generated at 820. If the drag or move continues for a longer time and stays within a certain area or certain distance from the first touch, a Hold user interface event is generated at 822. It needs to be noted that the Hold event may be generated without generating the Touch event. During the Hold event timing, there may be a sequence of driver drag, up and down events that are so small in distance or so close together in time that they do not generate a user interface event on their own, but instead contribute to the Hold user interface event.

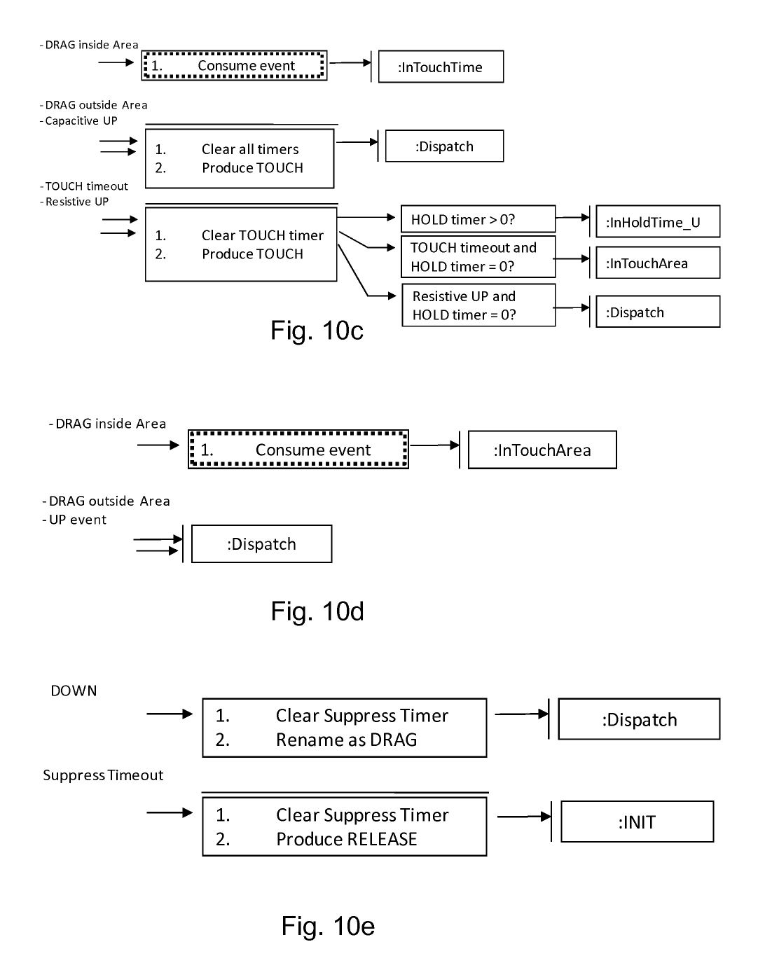

FIG. 9 shows a method for gesture based user input according to an example embodiment. At stage 910, hardware events and signals such as down or drag are received. The events and signals may be filtered or otherwise processed at stage 920, for example by applying filtering as explained earlier. At stage 930, low-level driver data is received, for example indicative of hardware events. These low-level data or events may be formed into user interface events at stage 940, and the respective modifiers at stage 945, as has been explained earlier. In other words, the lower level signals and events are “collected” into user interface events and their modifiers. At stage 948, new events such as hold events may be formed from either low-level data or other user interface events, or both. It needs to be noted that the order of the above steps may vary, for example, filtering may happen later in the process and hold events may be formed earlier in the process.

The user interface events with respective modifiers may then be forwarded to gesture recognizers, possibly by or through a gesture engine. At stages 951, 952 and so on, a start of a gesture recognized by the respective gesture recognizer may be recognized. The different gesture recognizers may be arranged to operate so that only one gesture may be recognized at one time, or so that multiple gestures may be detected simultaneously. This may bring about the benefit that also multi-gesture input may be used in applications. At stages 961, 962 and so on, the completed gestures recognized by the respective gesture recognizers are detected. At stage 970, the detected/recognized gestures are sent to applications and possibly the operating system so that they can be used for input. It needs to be noted that both the start of the gestures and the complete gestures may be forwarded to applications. This may have the benefit that applications may react earlier to gestures if they do not have to wait for the gesture to end. At stage 980, the gestures are then used for input by the applications.

As an example, gesture recognition may operate as follows. The gesture engine may receive all or essentially all user interface events in a given screen area, or even the entire screen. In other words, the operating system may give each application a window (screen area) and the application uses this area for user input and output. The user interface events may be given to the gesture engine so that the gesture recognizers are in a specific order, such that certain gestures will activate themselves first and others later, if there are user interface events left. Gestures that are to be recognized across the entire screen area may be placed before the ones that are more specific. In other words, the gesture engine is configured to receive the user interface events of a collection of windows. Using a browser application as an example, the gesture recognizers for gestures that are to be recognized by the browser (e.g. panning, pinch zooming, etc.) receive user interface events before e.g. Flash applications, even if the user interface events originated in the Flash window. Another example is double-tap; in the case of the browser, the sequence of taps may not fall within the same window where the first tap originated. Since the gesture engine receives all taps, it may recognize the double tap in this case, too. Yet another example is the drag; the movement may extend beyond the original window where the drag started. Since the gesture engine receives the user interface events from a plurality of windows or even the whole user interface area, it may be able to detect gestures spanning the window area of multiple applications.

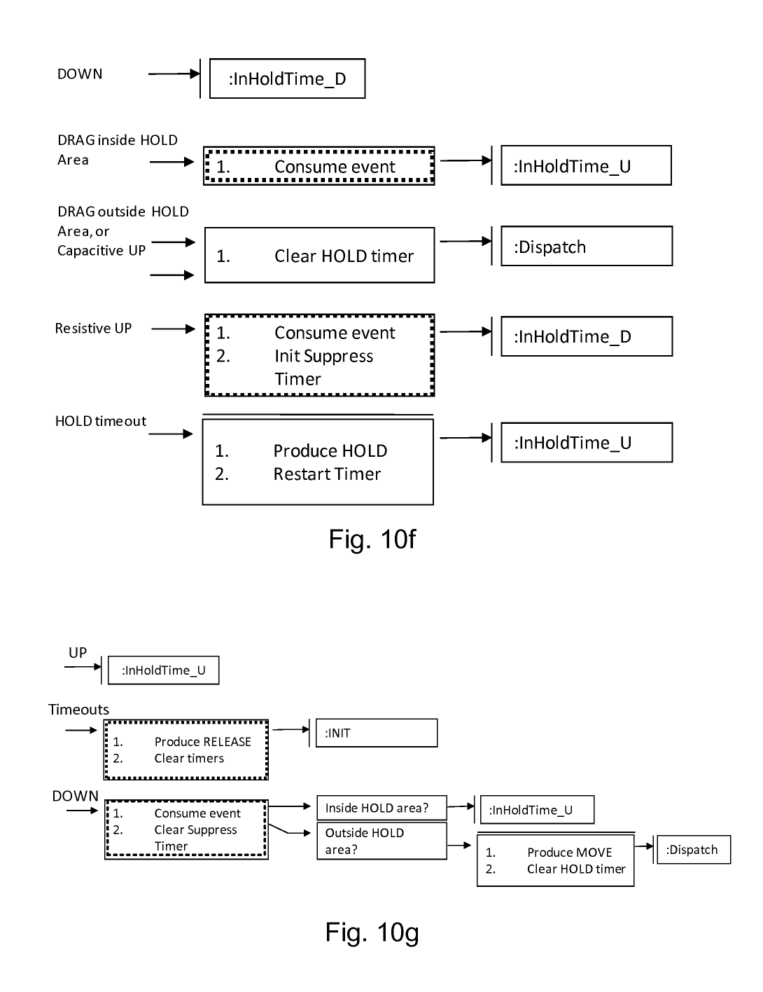

FIGS. 10a-10g show examples of state and event diagrams for producing user interface events according to an example embodiment.

It needs to be understood that different implementations of the states and their functionality may exist, and the different functionality may reside in various states. In this example embodiment, the different states may be described as follows. The Init state is the state where the state machine resides before anything has happened, and where is returns after completing all operations emanating from a user input. The individual input streams start from the Init state. The Dispatch state is a general state of the state machine if no touch, hold or suppress timers are running. The InTouchTime state is a state where the state machine resides after the user has touched the input device, and is ended by lifting the touch, moving away from the touch area or by holding a long enough time in place. The state also filters some accidental up and down events away. A purpose of the state is to allow settling of the touch input before generating a user interface event (the fingertip may be moving slightly, a stylus may jump a bit or other similar micro movement may happen). The InTouchArea state is a state that filters events away that stay in the touch area (events from micro movements). The InHoldTime_U state is a state that monitors the holding down of the touch, and produces a HOLD event if the hold stays for a long enough time. A purpose of this state is to filter away micro movements to see if a Hold user interface event is to be generated. The InHoldTime_D state is used for handling up-down events during hold. The state Suppress_D use used to filter accidental up and down sequences away. The functionality of the Suppress_D state functionality may be advantageous in the context of resistive touch panels where such accidental up/down events may easily happen.

In the example of FIG. 10a, the state machine is in the Init state. When a touch down hardware event is received, the event is consumed (i.e. not passed further or allowed to be used later) and timers are initialized (consumption of an event is marked with a box with a dotted circumference as illustrated in FIG. 10a). If no timers are in use, a TOUCH user interface event is produced (production of an event is marked with a box having a horizontal line on top as illustrated in FIG. 10a). After this, if the Hold Timer >0, the state machine goes into the InHoldTime_U state (state transition is marked with a box having a vertical line on the left side). If Touch Area >0, the state machine goes into InTouchArea state to determine whether the touch stays inside the original area. Otherwise, the state machine goes into the Dispatch state. Other events than down are erroneous and may be ignored.

In the example of FIG. 10b, the state machine is in the Dispatch state. If a drag or up hardware event is received, the event is consumed. For a capacitive touch device, a RELEASE user interface event is produced, and for a resistive touch device, a RELEASE is produced if there is no suppress timer active. After producing the RELEASE, the state machine goes into the Init state. For a resistive touch device, if there is an active suppress timer, the timer is initialized, and the state machine goes into the Suppress_D state. If a drag hardware event is received, a MOVE user interface event is produced. If the criteria for a HOLD user interface event are not matched, the state machine goes into the Dispatch state. If the criteria for a HOLD are matched, the hold timer is initialized, and the state machine goes into the InHoldTime_U state.

In the example of FIG. 10c, the filtering of hardware events in the InTouchTime state is shown. If a drag hardware event is received inside the (initial) touch area, the event is consumed and the state machine goes into InTouchTime state. If a drag event or an up event in a capacitive device outside the predetermined touch area is received, all timers are cleared and a TOUCH user interface event is produced. The state machine then goes into the Dispatch state. If a TOUCH timeout event or an up event from a resistive touch device is received, the TOUCH timer is cleared and a TOUCH event is produced. If the HOLD timer >0, the state machine goes into the InHoldTime_U state. If there is no active HOLD timer and a TOUCH timeout was received, the state machine goes into the InTouchArea state. If a resistive up event was received and there is no active HOLD timer, the state machine goes into the Dispatch state. The state machine of FIG. 10c may have the advantage of eliminating sporadic up/down events during HOLD detection.

In the example of FIG. 10d, the filtering of hardware events in the InTouchArea state is shown. If a drag hardware event is received inside the touch area, the event is consumed and the state machine stays in the InTouchArea state. In other words, if drag events that are sufficiently close to the original down event are received, the state machine filters out these events as micro-drag events, as described earlier. If a drag event is received outside the area, or an up event is received, the state machine goes into the Dispatch state.

In the example of FIG. 10e, the filtering of accidental up and down hardware events in the Suppress_D state is shown. If a down hardware event is received, the suppress timer is cleared and the event is renamed as a drag hardware event. The state machine then goes into the Dispatch state. If a suppress timeout event is received, the suppress timer is cleared and a RELEASE user interface event is produced. The state machine then goes into the Init state. In other words, the state machine replaces an accidental up event followed by a down event with a drag event. RELEASE is produced if no down event is detected during a timeout. The Suppress_D state may be used for resistive input devices.

In the example of FIG. 10f, the filtering of hardware events during hold in the InHoldTime_U state is shown. If a down hardware event is received, the state machine goes into the InHoldTime_D state. If a drag event is received inside the hold area, the event is consumed and the state machine stays in the InHoldTime_U state. If a drag event outside the hold area or a capacitive up event is received, the hold timer is cleared and the state machine goes into the Dispatch state. If an up event from a resistive input device is received, the event is consumed, the suppress timer is initialized, and the state machine goes into the InHoldTime_D state. If a HOLD timeout is received, a HOLD user interface event is produced, and the HOLD timer is restarted. The state machine stays in the InHoldTime_U state. In other words, a HOLD user interface event is produced when the HOLD timer produces a timeout, and HOLD detection is aborted if a drag event is received outside the hold area, or a valid up event is received.

In the example of FIG. 10g, the filtering of hardware events during hold in the InHoldTime_D state is shown. If an up hardware event is received, the state machine goes into the InHoldTime_U state. If a timeout is received, a RELEASE user interface event is produced, timers are cleared and the state machine goes into the Init state. If a down hardware event is received, the event is consumed, and the suppress timer is cleared. If the event was received inside the hold area, the state machine goes into the InHoldTime_U state. If the event was received outside the hold area, a MOVE user interface event is produced, the hold timer is cleared and the state machine goes into the Dispatch state. In other words, the InHoldTime_D state is entered if an up event was previously received (in InHoldTime_U). The state waits for a down event for a specified time, and if a timeout is produced, the state produces a RELEASE user interface event. If a down event is received, the state machine returns to the previous state if the event was received inside the hold area, and if the event was received outside the hold area, a MOVE event is produced.

The invention may provide advantages through the abstraction of the hardware or low-level events into higher-level user interface events.

For example, a resistive touch screen may produce phantom events when the user changes direction of the movement or stops the movement. According to an example embodiment, such low-level phantom events may not reach the gesture recognizers, since the system first generates higher-level user interface events from the low-level events. In this process of generating the user interface events, the phantom events are filtered out through the use of timers and other means as explained earlier. Along the same lines, the higher-level user interface events may be simpler to use in programming applications for the platform where embodiments of the invention are used. The invention may also allow simpler implementation of multi-gesture recognition. Furthermore, switching from one gesture to another may be simpler to detect. For example, the generation of a Hold user interface event may make it unnecessary for the recognizer of Panning or other gestures to detect the end of the movement, since another gesture recognizer takes care of that. Since the user interface events are generated consistently from the low-level events, the invention may also provide predictability and ease of testing for applications. Generally, the different embodiments may simplify the programming and use of applications on a platform where the invention is applied.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1. A method for receiving user input, comprising:
receiving a low-level event from a user interface input device,
forming a user interface event using said low-level event,
forming information on a modifier for said user interface event,
forming gesture information from said user interface event and said modifier, and
using said gesture information as user input to an apparatus.

2. A method according to claim 1, further comprising:
forwarding said user interface event and said modifier to a gesture recognizer, and
forming said gesture information by said gesture recognizer.

3. A method according to claim 1, further comprising:
receiving a plurality of user interface events from a user interface input device,
forwarding said user interface events to a plurality of gesture recognizers, and
forming at least two gestures by said gesture recognizers.

4. A method according to claim 1, wherein the user interface event is one of the group of touch, release, move and hold.

5. A method according to claim 1, further comprising:
forming said modifier from at least one of the group of time information, area information, direction information, speed information, and pressure information.

6. A method according to claim 1, further comprising:
forming a hold user interface event in response to a touch input or key press input being held in place for a predetermined time, and
using said hold event in forming said gesture information.

6. A method according to claim 1, further comprising:
receiving at least two distinct user interface events from a multi-touch touch input device, and
using said at least two distinct user interface events for forming a multi-touch gesture.

8. A method according to claim 1, wherein said user interface input device comprises at least one of the group of a touch screen, a touch pad, a pen, a mouse, a haptic input device, a data glove and a data suit.

9. A method according to claim 1, wherein said user interface event is one of the group of touch down, release, hold and move.

10. An apparatus comprising at least one processor, memory including computer program code, the memory and the computer program code configured to, with the at least one processor, cause the apparatus to at least:
receive a low-level event from a user interface input module,
form a user interface event using said low-level event,
form information on a modifier for said user interface event,
form gesture information from said user interface event and said modifier, and
use said gesture information as user input to an apparatus.

11. An apparatus according to claim 10, further comprising computer program code configured to, with the at least one processor, cause the apparatus to at least:
forward said user interface event and said modifier to a gesture recognizer, and
form said gesture information by said gesture recognizer.

11. An apparatus according to claim 10, further comprising computer program code configured to, with the processor, cause the apparatus to at least:
receive a plurality of user interface events from a user interface input device,
forward said user interface events to a plurality of gesture recognizers, and
form at least two gestures by said gesture recognizers.

13. An apparatus according to claim 10, wherein the user interface event is one of the group of touch, release, move and hold.

14. An apparatus according to claim 10, further comprising computer program code configured to, with the processor, cause the apparatus to at least:
form said modifier from at least one of the group of time information, area information, direction information, speed information, and pressure information.

15. An apparatus according to claim 10, further comprising computer program code configured to, with the processor, cause the apparatus to at least:
form a hold user interface event in response to a touch input or key press input being held in place for a predetermined time, and
use said hold event in forming said gesture information.

16. An apparatus according to claim 10, further comprising computer program code configured to, with the processor, cause the apparatus to at least:
receive at least two distinct user interface events from a multi-touch touch input device, and
use said at least two distinct user interface events for forming a multi-touch gesture.

17. An apparatus according to claim 10, wherein the user interface module comprises at least one of the group of a touch screen, a touch pad, a pen, a mouse, a haptic input device, a data glove and a data suit.

18. An apparatus according to claim 10, wherein the apparatus is one of a computer, portable communication device, a home appliance, an entertainment device such as a television, a transportation device such as a car, ship or an aircraft, or an intelligent building.

19. A system comprising at least one processor, memory including computer program code, the memory and the computer program code configured to, with the at least one processor, cause the system to at least
receive a low-level event from a user interface input module,
forming a user interface event using said low-level event,
form information on a modifier for said user interface event,
form gesture information from said user interface event and said modifier, and
use said gesture information as user input to an apparatus.

20. A system according to claim 19, wherein the system comprises at least two apparatuses arranged in communication connection to each other, and wherein a first apparatus of said at least two apparatuses is arranged to receive said low-level event and a second apparatus of said at least two apparatuses is arranged to form said gesture information in response to receiving a user interface event from said first apparatus.

21. An apparatus comprising, processing means, memory means, and
means for receiving a low-level event from a user interface input means,
means for forming a user interface event using said low-level event,
means for forming information on a modifier for said user interface event,
means for forming gesture information from said user interface event and said modifier, and
means for using said gesture information as user input to an apparatus.

22. A computer program product stored on a computer readable medium and executable in a data processing device, the computer program product comprising:
a computer program code section for receiving a low-level event from a user interface input device,
a computer program code section for forming a user interface event using said low-level event,
a computer program code section for forming information on a modifier for said user interface event,
a computer program code section for forming gesture information from said user interface event and said modifier, and
a computer program code section for using said gesture information as user input to an apparatus.

23. A computer program product according to claim 22 wherein the computer program product is an operating system.
